(19) United States
(12) Patent Application Publication
(10) Pub. No.: US 2023/0409366 A1
(43) Pub. Date: Dec. 21, 2023

(54) DYNAMIC CONFIGURATION OF STATISTICS ENDPOINT IN VIRTUALIZED COMPUTING ENVIRONMENT

(71) Applicant: VMware, Inc., Palo Alto, CA (US)

(72) Inventors: Jianqiao SUN, Shanghai (CN); Yang YANG, Shanghai (CN); Junlong GAO, Santa Clara, CA (US); Jianrong ZHAO, Shanghai (CN); Jin FENG, Shanghai (CN); Chengmao LU, Shanghai (CN)

(73) Assignee: VMware, Inc., Palo Alto, CA (US)

(21) Appl. No.: 17/840,907

(22) Filed: Jun. 15, 2022

(51) Int. Cl. G06F 9/455

(52) U.S. Cl. CPC G06F 9/45558; G06F 2009/45595; G06F 2009/45591

(57) ABSTRACT

Example methods and systems associated with dynamic configuration of a statistics endpoint in a virtualized computing environment have been disclosed. One example method includes in response to receiving a first request, by a host in the virtualized computing environment, accepting a configuration file specified in the first request; in response to receiving a second request, by the host, parsing a rule based on the configuration file and collecting statistics based on the rule; processing, by the host, the statistics collected based on the rule; and sending, by the host, the processed statistics to a monitoring terminal.

### BACKGROUND

Unless otherwise indicated herein, the approaches described in this section are not admitted to be prior art by inclusion in this section.

Virtualization allows the abstraction and pooling of hardware resources to support virtual machines (VMs) in a virtualized computing environment. For example, through server virtualization, virtualized computing instances such as VMs running different operating systems may be supported by the same physical machine (e.g., referred to as a “host”). Each VM is generally provisioned with virtual resources to run an operating system and applications. The virtual resources may include central processing unit (CPU) resources, memory resources, storage resources, network resources, etc.

In addition, through storage virtualization, storage resources of a cluster of hosts may be aggregated to form a single shared pool of storage including one or more datastores/object stores. VMs supported by the hosts within the cluster may then access the pool to store data. The data is stored and managed in a form of a data container called an object or a storage object. An object is a logical volume that has its data and metadata distributed in the pool.

Moreover, through network virtualization, for example software defined networking, benefits similar to server virtualization and storage virtualization may be derived for networking services. For example, logical overlay networks may include various components and be provided that are decoupled from the underlying physical network infrastructure, and therefore may be provisioned, changed, stored, deleted and restored programmatically without having to reconfigure the underlying physical hardware, such as one or more physical network interface controller (NICs) of hosts.

In a virtualized computing environment, such as hyperconverged infrastructure (HCl) including the server virtualization, the storage virtualization, the network virtualization and management capabilities to manage such virtualizations, a virtualization manager may abstract and pool underlying resources and dynamically allocates the resources to applications running in VMs on hosts.

Various types of statistics in a virtualized computing environment are collected for the applications running in the environment. For example, an application sensitive to network bandwidth utilizations may need network traffic statistics in the virtualized computing environment, and an application sensitive to storage input/output (I/O) utilizations may need storage I/O statistics in the virtualized computing environment to run efficiently or properly.

Some known statistics collection solutions can only monitor certain predefined statistics. However, such predefined statistics may not provide relevant or useful information. As a result, all the hardware, storage and network resources of hosts in the environment used to monitor, collect and/or store the predefined statistics are essentially wasted. In addition, these known solutions cannot be easily modified to monitor or collect different statistics that may be more relevant or useful.

### BRIEF DESCRIPTION OF DRAWINGS

FIG. 1 is a schematic diagram illustrating an example virtualized computing environment;

FIG. 2 illustrates a block diagram illustrating an example system that supports dynamically configuring a statistics endpoint in a virtualized computing environment, according to some embodiments of the present disclosure;

FIG. 3 is an example configuration file in a text form, according to some embodiments of the present disclosure; and

FIG. 4 is a flow diagram of an example method to dynamically configure a statistics endpoint in a virtualized computing environment, according to some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used throughout the present disclosure to describe various elements, these elements should not be limited by these terms. These terms are used to distinguish one element from another. In other embodiments, a first element may be referred to as a second element, and vice versa.

In this disclosure, an “endpoint” may refer to a computing device connected to a network. A “statistics endpoint” may refer to an endpoint configured to collect customized statistics in response to a request from another computing device.

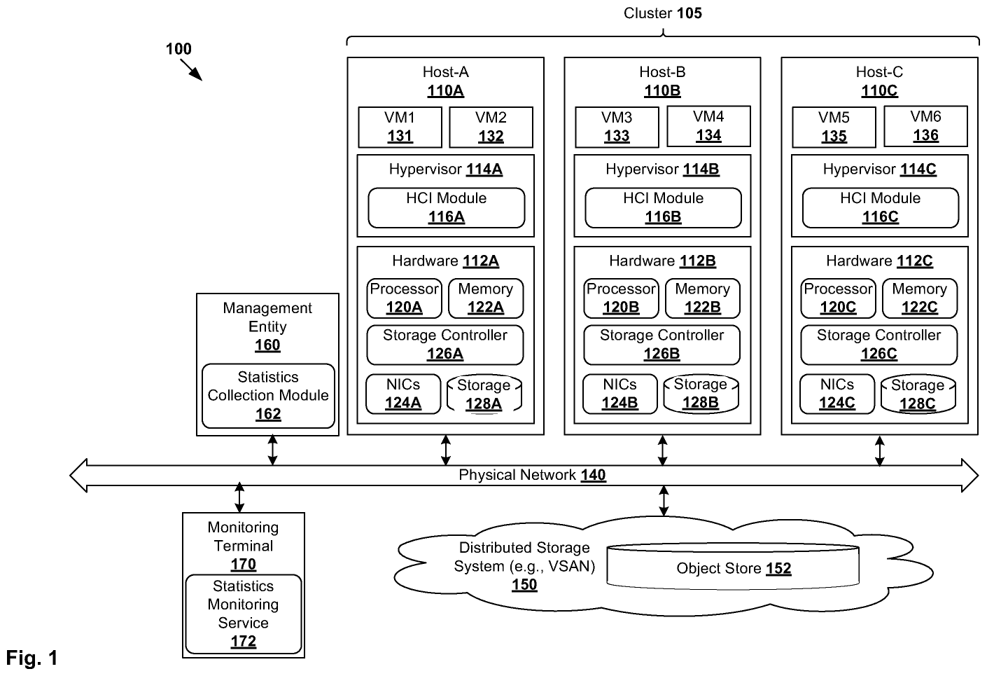

Challenges relating to dynamically configuring a statistic endpoint in a virtualized computing environment will now be explained in more detail using FIG. 1, which is a schematic diagram illustrating example virtualized computing environment 100. It should be understood that, depending on the desired implementation, virtualized computing environment 100 may include additional and/or alternative components than that shown in FIG. 1.

In the example in FIG. 1, virtualized computing environment 100 includes cluster 105 having one or more hosts that are inter-connected via physical network 140. For example, cluster 105 includes host-A 110A, host-B 110B and host-C 110C. In the following, reference numerals with a suffix “A” relates to host-A 110A, suffix “B” relates to host-B 110B, and suffix “C” relates to host-C 110C. Although three hosts (also known as “host computers”, “physical servers”, “server systems”, “host computing systems”, etc.) are shown for simplicity, clusters 105 may include any number of hosts. Although a single cluster 105 is shown for simplicity, virtualized computing environment 100 may include any number of clusters.

Each host 110A/110B/110C in cluster 105 includes suitable hardware 112A/112B/112C and executes virtualization software such as hypervisor 114A/114B/114C to maintain a mapping between physical resources and virtual resources assigned to various virtual machines. For example, Host-A 110A supports VM1 131 and VM2 132; host-B 110B supports VM3 133 and VM4 134; and host-C 110C supports VM5 135 and VM6 136. In practice, each host 110A/110B/110C may support any number of virtual machines, with each virtual machine executing a guest operating system (OS) and applications. Hypervisor 114A/114B/114C may also be a “type 2” or hosted hypervisor that runs on top of a conventional operating system (not shown) on host 110A/110B/110C.

Although examples of the present disclosure refer to “virtual machines,” it should be understood that a “virtual machine” running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system such as Docker, etc.; or implemented as an operating system level virtualization), virtual private servers, client computers, etc. The virtual machines may also be complete computation environments, containing virtual equivalents of the hardware and software components of a physical computing system.

Hardware 112A/112B/112C includes any suitable components, such as processor 120A/120B/120C (e.g., central processing unit (CPU)); memory 122A/122B/122C (e.g., random access memory); network interface controllers (NICs) 124A/124B/124C to provide network connection; storage controller 126A/126B/126C that provides access to storage resources 128A/128B/128C, etc. Corresponding to hardware 112A/112B/112C, virtual resources assigned to each virtual machine may include virtual CPU, virtual memory, virtual machine disk(s), virtual NIC(s), etc.

Storage controller 126A/126B/126C may be any suitable controller, such as redundant array of independent disks (RAID) controller, etc. Storage resource 128A/128B/128C may represent one or more disk groups. In practice, each disk group represents a management construct that combines one or more physical disks, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, Integrated Drive Electronics (IDE) disks, Universal Serial Bus (USB) storage, etc.

Through storage virtualization, hypervisors 114A/114B/114C implement HCl modules 116A/116B/116C to aggregate storage resources 128A/128B/128C to form distributed storage system 150, which represents a shared pool of storage resources. For example, in FIG. 1, HCl modules 116A/116B/116C aggregate respective local physical storage resources 128A/128B/128C into an object store (datastore) 152. Data (e.g., virtual machine data) stored in object store 152 may be placed on, and accessed from, one or more of storage resources 128A/128B/128C. In practice, distributed storage system 150 may employ any suitable technology, such as Virtual Storage Area Network (vSAN) from VMware, Inc.

Through network virtualization, hypervisors 114A/114B/114C implement HCl modules 116A/116B/116C to handle egress packets from, and ingress packets to, corresponding VMs. In virtualized computing environment 100, HCl modules 116A/116B/116C may implement logical switches and logical distributed routers (DRs) in a distributed manner and can span multiple hosts. Logical switches may provide logical layer-2 connectivity and logical DRs may provide logical layer-3 connectivity. In virtualized computing environment 100, logical networks (also referred to as overlay networks or logical overlay networks) may be provisioned, changed, stored, deleted and restored programmatically without having to reconfigure the underlying physical hardware architecture. A logical network may be formed using any suitable tunneling protocol, such as Virtual eXtensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks.

In virtualized computing environment 100, management entity 160 provides management functionalities to manage components in virtualized computing environment 100, such as cluster 105, hosts 110A/110B/110C, virtual machines 131, 132, 133, 134, 135 and 136, etc. Management entity 160 is connected to hosts 110A/110B/110C via physical network 140. Management entity 160 may include statistics collection module 162, which is configured to collection statistics from hosts 110A/110B/110C in cluster 105.

Monitoring terminal 170 is connected to virtualized computing environment 100 including management entity 160 and hosts 110A/110B/110C via physical network 140. Monitoring terminal 170 is configured to obtain statistics from statistics collection module 162 and run statistics monitoring service 172 based on the obtained statistics. Statistics monitoring service 172 may present the obtained statistics via a user interface accessible by a user of monitoring terminal 170. Monitoring terminal 170 is an entity outside of virtualized computing environment 100 and therefore resources of monitoring terminal 170 is independent from resources abstracted in virtualized computing environment 100.

Conventionally, statistics collection module 162 is configured to collect predefined statistics from hosts 110A/110B/110C, and statistics monitoring service 172 is configured to obtain the predefined statistics from statistics collection module 162 and present the predefined statistics via a user interface. However, there are certain disadvantages. For example, the predefined statistics may not be raw statistics, and the processing of converting the raw statistics to the predefined statistics may result in data granularity loss. To collect non-predefined statistics having a higher data granularity, conventional solutions usually require performing code changes and rebuilding and redeploying a build, which takes nontrivial amount of time and efforts. In addition, in the scenarios that the predefined statistics does not provide useful or relevant information, underlying computing, storage and network resources to compute, store and transmit the predefined statistics in virtualized computing environment 100 are essentially wasted. For example, predefined statistics may be massive in sizes and are conventionally stored in distributed storage system 150 before statistics collection module 162 retrieves the predefined statistics, which can cause storage performance degradation in virtualized computing environment 100.

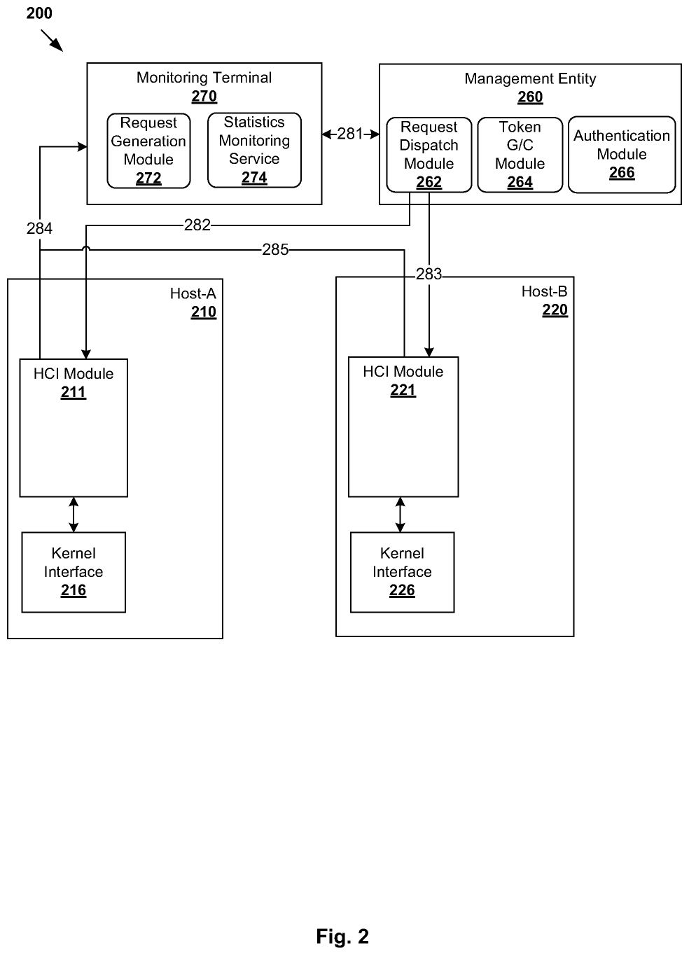

FIG. 2 illustrates a block diagram illustrating an example system 200 that supports dynamically configuring a statistics endpoint in a virtualized computing environment, according to some embodiments of the present disclosure. System 200 may include, but not limited to, host-A 210, host-B 220, management entity 260 and monitoring terminal 270. In some embodiments, in conjunction with FIG. 1, hosts 210/220 may correspond to hosts 110A/110B. System 200 may include additional hosts, such as host 110C in FIG. 1, which is not shown in FIG. 2 for simplicity. Any host in system 200 may be a statistics endpoint. In some embodiments, in conjunction with FIG. 1, management entity 260 may correspond to management entity 160, and monitoring terminal 270 may correspond to monitoring terminal 170.

In some embodiments, monitoring terminal 270 includes, but not limited to, request generation module 272 and statistics monitoring service 274. Management entity 260 includes, but not limited to, request dispatch module 262, token generation and checking (G/C) module 264, and authentication module 266. Monitoring terminal 270 and management entity 260 may communicate via connection 281, which may be supported by physical network 140 of FIGS. 1.

In some embodiments, monitoring terminal 270 may try to access management entity 260 through authentication module 266 with a username and a password at a first time point. In response authentication module 266 determining that the username and the password from monitoring terminal 270 are valid, token G/C module 264 is configured to generate a token and send the token to monitoring terminal 270 via connection 281. Token G/C module 264 may be configured to set the token to be “current” for a period of time. During this period of time, monitoring terminal 270 may access management entity 260 using the token without reentering the username and the password. Token G/C module 264 may check the status of the token from monitoring terminal 270. For example, in response to token G/C module 264 determining that the token is current, monitoring terminal 270 is allowed to access management entity 260. Otherwise, monitoring terminal 270's attempt to access management entity 260 is rejected.

In some embodiments, request generation module 272 is configured to generate a first request destined for one or more hosts (e.g., host-A 210, host-B 220, etc.). For this generated first request to be dispatched to the one or more endpoints, monitoring terminal 270 needs to have access to management entity 260, so that request dispatch module 262 may dispatch the first request to host-A 210, host-B 220 or both. As set forth above, monitoring terminal 270 may use the token maintain access to management entity 260.

In some embodiments, the first request may be a POST request supported by the Hypertext Transfer Protocol (HTTP). The POST request may request an endpoint (e.g., host-A 210 or host-B 220) receiving the POST request to accept data enclosed in a body of a request message of the POST request. For example, the first request may include the token, and the body of the first request may specify information associated with a configuration file. In some other embodiments, the first request may be a string holding data that can be represented in an editable text form.

One example of the first request may read as:

curl -skH ‘Authorization: Bearer 92eb64c3-1926-47f4-a504-ab4f82’-X POST -data-binary@metrics_resource.yaml-H “Content-type: text/x-yam I” https://<11.1.1.1>/metrics_path.
Here, “92eb64c3-1926-47f4-a504-ab4f82” is the token, “data-binary” is an approach of uploading a file in a binary form, “metrics_resource.yaml” is the file name of the configuration file, and “https://<11.1.1.1>/metrics_path” is the Uniform Resource Locator (URL) of the configuration file.

In some embodiments, in response to token G/C module 264 determining that “92eb64c3-1926-47f4-a504-ab4f82” is a current token, monitoring terminal 270 is allowed to access management entity 260, including request dispatch module 262. In some embodiments, request dispatch module 262 is configured to dispatch the first request to one or more endpoints in system 200 (e.g., host-A 210, host-B 220, other hosts or all hosts in system 200) via connections 282 and 283.

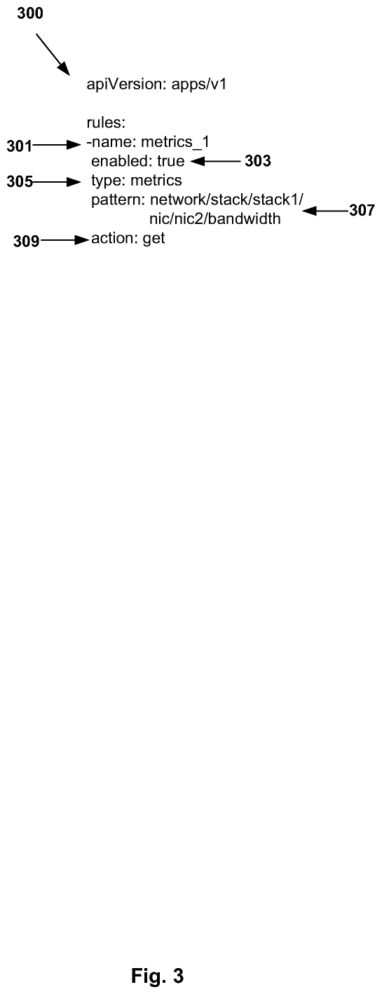

FIG. 3 is an example configuration file in a text form 300, according to some embodiments of the present disclosure. In one example, text form 300 may describe rules. Text form 300 includes, but not limited to, name of rules “metrics_1” 301, rules enabled status “true” 303, rules type “metrics” 305, rules pattern “network/stack/stack1/nic/nic2/bandwidth” 307 and rules action “get” 309. In some embodiments, rules enabled status “true” 303 may reflect that these rules are enabled, and rules type “metrics” 305 may reflect that these rules are categorized as the “metrics” type. Rules pattern “network/stack/stack1/nic/nic2/bandwidth” 307 may refer to a kernel path to a particular file that saves bandwidth information (e.g., inbound and outbound packet counts) of a second NIC (i.e., nic/nic2) in a first network stack (i.e., stack/stack1), and rules action “get” 309 may refer to the action of obtaining information from the kernel path specified in 307.

In some embodiments, rules pattern 307 may be edited to obtain other information so that statistics stored according to certain kernel paths may be obtained. In other words, by editing rules pattern 307, customized statistics that is stored according to different kernel paths may be obtained. In conjunction with FIGS. 2, assuming that host-A 210 includes two network stacks, each further including two NICs. To obtain bandwidth information with a lower data granularity (e.g., at the level of network stack), rules pattern 307 may be edited to “Thetwork/stack/(?P<stackname>.*)/bandwidth.” This refers to kernel paths where bandwidth information associated with all network stacks of host-A 210 are saved. In some other embodiments, to obtain bandwidth information with a higher data granularity (e.g., at the level of NIC), rules pattern 307 may be edited to “Thetwork/stack/(?P<stackname>.*)/nic/(?P<nicname>.*)/bandwidth.” This refers to kernel paths where bandwidth information associated with all NICs of all network stacks of host-A 210 are saved. In yet other embodiments, to obtain bandwidth information associated with a certain NIC having NIC names starting from ABC, rules pattern 307 may be edited to “Thetwork/stack/(?P<stackname>.*)/nic/(?P<nicname>ABC.*)/bandwidth.” This refers to kernel paths where bandwidth information associated with NICs having names starting from ABC in all network stacks of host-A 210 are saved. Therefore, customized statistics with different data granularities and associated with specific components may be obtained.

In some embodiments, referring back to FIG. 2, in response to a host (e.g., host-A 210) receiving the first request, host-A 210 is configured to accept the configuration file specified in the first request so that host-A 210 can be dynamically configured to be a statistics endpoint based on the configuration file.

In some embodiments, after the first request is dispatched among hosts in system 200, request generation module 272 is configured to generate a second request. The second request may be a GET request supported by the Hypertext Transfer Protocol (HTTP). The GET request may request to retrieve information from an entity (e.g., host-A 210 or host-B 220) receiving the GET request. In some embodiments, the second request may include the token and specify a format of the retrieved information. In some other embodiments, the second request may be a string holding data that can be represented in an editable text form.

For example, an example second request may read as:

curl -skH ‘Authorization: Bearer 92eb64c3-1926-47f4-a504-ab4f82’ https://<11.1.1.1>/metrics_path.
In the second request, “92eb64c3-1926-47f4-a504-ab4f82′” is the token and “https://<11.1.1.1>/metrics_path” is the Uniform Resource Locator (URL) of the configuration file that accepted in response to the first request.

In some embodiments, in response to token G/C module 264 determines that “92eb64c3-1926-47f4-a504-ab4f82”′ is an up-to-dated token, monitoring terminal 270 is allowed to access management entity 260, including request dispatch module 262. In some embodiments, request dispatch module 262 is configured to dispatch the second request to one or more hosts in system 200 (e.g., host-A 210, host-B 220, other hosts or all hosts in system 200) via connections 282 and 283.

In some embodiments, in response to a host (e.g., host-A 210) receiving the second request, host-A 210 is configured to parse a rule based on accepted configuration file and collect statistics based on the parsed rule. Therefore, the collected statistics may be customized by dynamically editing the configuration file. In some embodiments, HCl module 211 of host-A 210 is configured to collect kernel statistics associated with host-A 210 from kernel interface 216. Similarly, HCl module 221 of host-B 220 is configured to collect kernel statistics associated with host-B 220 from kernel interface 226.

In some embodiments, in conjunction with FIG. 3, host-A 210 is configured to parse a rule based on rules patterns 307 and rules action 309. Some example rules patterns 307 have been discussed above. For example, rules pattern 307 of “Thetwork/stack/(?P<stackname>.*)/bandwidth” and rules action 309 of “get” may be parsed to a rule of obtaining bandwidth information of all network stacks of host-A 210. Similarly, rules pattern 307 of “Thetwork/stack/(?P<stackname>.*)/nic/(?P<nicname>.*)/bandwidth” and rules action 309 of “get” may be parsed to a rule of obtaining bandwidth information of all NICs in all network stacks of host-A 210.

In some embodiments, in response to host-A 210 collecting statistics based on the parsed rule, host-A 210 is configured to process collected statistics. For example, host-A 210 is configured to convert the collected statistics to a format that the configuration file specifies. In addition, host-A 210 may also be configured to add one or more tags to the collected statistics so that the collected statistics may be further categorized. The tags may be associated with an identifier of host-A 210 itself, an identifier of a specific NIC of host-A 210, an identifier of a specific disk of host-A 210, etc. Similarly, host-B 220 may be also configured to collect statistics based on the parsed rule and process collected statistics as host-A 210 does.

In some embodiments, in response to host-A 210 processing the collected statistics, host-A 210 is configured to send the processed collected statistics associated with host-A 210 to monitoring terminal 270 via connection 284. Similarly, host-B 220 may also be configured to send the processed collected statistics associated with host-B 220 to monitoring terminal 270 via connection 285.

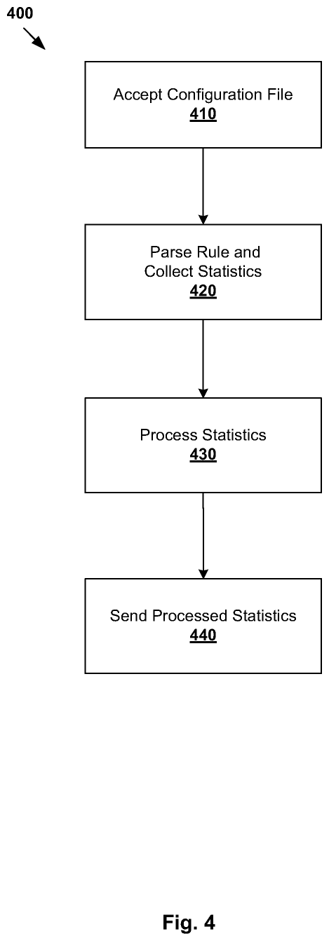

FIG. 4 is a flow diagram of an example process 400 to dynamically configure a statistics endpoint in a virtualized computing environment, according to some embodiments of the present disclosure. Example process 400 may include one or more operations, functions, or actions illustrated by one or more blocks, such as 410 to 440. The various blocks may be combined into fewer blocks, divided into additional blocks, and/or eliminated depending on the desired implementation. In some embodiments, process 400 may be performed by host-A 110A illustrated in FIG. 1 or host-A 210 illustrated in FIG. 2.

Process 400 may start with block 410 “accept configuration file.” In some embodiments, in conjunction with FIG. 2, in response to host-A 210 receiving a first request (e.g., a POST request), host-A 210 is configured to accept a configuration file specified in the first request. Block 410 may be followed by block 420.

In some embodiments, in block 420 “parse rule and collect statistics,” in response to host-A 210 receiving a second request (e.g., a GET request), host-A 210 is configured to parse a rule based on the configuration file accepted in block 410 and collect statistics associated with host-A 210 based on the parsed rule. Block 420 may be followed by block 430.

In some embodiments, in block 430 “process statistics,” in response to host-A 210 collecting statistics based on the rule parsed in block 420, host-A 210 is configured to process the statistics collected in block 420. In some embodiments, host-A 210 is configured to convert statistics collected in block 420 in a format that the configuration file or the second request specifies. In addition, host-A 210 may be also configured to add one or more tags to the statistics collected in block 420. The tags may be associated with an identifier of host-A 210 itself, an identifier of a specific network interface controller (NIC) of host-A 210, an identifier of a specific disk of host-A 210, etc. Block 430 may be followed by block 440.

In some embodiments, in block 440 “send processed statistics,” in response to host-A 210 processing statistics in block 430, host-A 210 is configured to send the processed statistics to monitoring terminal 270. In some embodiments, monitoring terminal 270 is configured to present the processed statistics on a user interface through statistics monitoring service 274.

Compared to conventional approaches, process 400 has some advantages. For example, dynamic and customized statistics to be collected may be easily defined by editing texts of the configuration file. Therefore, non-predefined, dynamic and customized statistics with a higher data granularity may be collected without performing codes changes, rebuilding and redeploying a build. In addition, the non-predefined and dynamic statistics can be customized as needed, the underlying computing, storage and network resources in the virtualized computing environment will not be wasted. Moreover, the collected statistics will be sent to the monitoring terminal and not be stored in the virtualized computing environment for a long time. Therefore, storage performance of the virtualized computing environment will not be impacted by the collected statistics potentially being massive in sizes.

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 4.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of the present disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non-recordable media (e.g., read-only memory (ROM), random access memory (RAM), magnetic disk or optical storage media, flash memory devices, solid-state drive, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

1. A method to dynamically configure a statistics endpoint in a virtualized computing environment, comprising:
in response to receiving a first request, by a host in the virtualized computing environment, accepting a configuration file specified in the first request;
in response to receiving a second request, by the host, parsing a rule based on the configuration file and collecting statistics based on the rule;
processing, by the host, the statistics collected based on the rule; and
sending, by the host, the processed statistics to a monitoring terminal.

2. The method of claim 1, wherein the first request is a first string holding data that can be represented in an editable text form and the second request is a second string holding data that can be represented in an editable text form.

3. The method of claim 1, wherein the configuration file is specified in a body of a request message of the first request.

4. The method of claim 1, wherein the collecting statistics further includes collecting kernel statistics associated with the host based on the rule through a kernel interface of the host.

5. The method of claim 1, wherein the processing the statistics further includes converting the statistics collected based on the rule in a format that the configuration file or the second request specifies or adding a tag of an identifier associated with the host.

6. The method of claim 1, wherein the first request includes a token to access a management entity in the virtualized computing environment for dispatching the first request to the host.

7. The method of claim 1, wherein the monitoring terminal is outside of the virtualized computing environment.

8. A non-transitory computer-readable storage medium that includes a set of instructions which, in response to execution by a processor of a computer system, cause the processor to perform a method to dynamically configure a statistics endpoint in a virtualized computing environment, the method comprising:
in response to receiving a first request, by a host in the virtualized computing environment, accepting a configuration file specified in the first request;
in response to receiving a second request, by the host, parsing a rule based on the configuration file and collecting statistics based on the rule;
processing, by the host, the statistics collected based on the rule; and
sending, by the host, the processed statistics to a monitoring terminal.

9. The non-transitory computer-readable storage medium of claim 8, wherein the first request is a first string holding data that can be represented in an editable text form and the second request is a second string holding data that can be represented in an editable text form.

10. The non-transitory computer-readable storage medium of claim 8, wherein the configuration file is specified in a body of a request message of the first request.

11. The non-transitory computer-readable storage medium of claim 8,
including additional instructions which, in response to execution by the processor of the computer system, cause the processor to collect kernel statistics associated with the host based on the rule through a kernel interface of the host.

12. The non-transitory computer-readable storage medium of claim 8, including additional instructions which, in response to execution by the processor of the computer system, cause the processor to convert the statistics collected based on the rule in a format that the configuration file or the second request specifies or add a tag of an identifier associated with the host.

13. The non-transitory computer-readable storage medium of claim 8, wherein the first request includes a token to access a management entity in the virtualized computing environment for dispatching the first request to the host.

14. The non-transitory computer-readable storage medium of claim 8, wherein the monitoring terminal is outside of the virtualized computing environment.

15. A statistics endpoint in a virtualized computing environment, comprising:
a processor; and
a non-transitory computer-readable medium having stored thereon instructions that, when executed by the processor, cause the processor to:
in response to receiving a first request, accept a configuration file specified in the first request;
in response to receiving a second request, parse a rule based on the configuration file and collect statistics based on the rule;
process the statistics collected based on the rule; and
send the processed statistics to a monitoring terminal.

16. The statistics endpoint of claim 15, wherein the first request is a first string holding data that can be represented in an editable text form and the second request is a second string holding data that can be represented in an editable text form.

17. The statistics endpoint of claim 15, wherein the configuration file is specified in a body of a request message of the first request.

18. The statistics endpoint of claim 15, wherein the non-transitory computer-readable medium has stored thereon additional instructions that, when executed by the processor, cause the processor to collect kernel statistics associated with the computer system based on the rule through a kernel interface of the computer system.

19. The statistics endpoint of claim 15, wherein the non-transitory computer-readable medium has stored thereon additional instructions that, when executed by the processor, cause the processor to convert the statistics collected based on the rule in a format that the configuration file or the second request specifies or add a tag of an identifier associated with the computer system.

20. The statistics endpoint of claim 15, wherein the first request includes a token to access a management entity in the virtualized computing environment for dispatching the first request to the host.

21. The statistics endpoint of claim 15, wherein the monitoring terminal is outside of the virtualized computing environment.
